(19) United States
(12) Patent Application Publication
(10) Pub. No.: US 2023/0240398 A1
(43) Pub. Date: Aug. 3, 2023

(54) CLOTHING

(71) Applicant: SHINTAIKINOUKENKYUUJO CO., LTD, Sendai-shi (JP)

(72) Inventor: Takashi SASAKI, Sendai-shi (JP)

(73) Assignee: SHINTAIKINOUKENKYUUJO CO., LTD, Sendai-shi (JP)

(21) Appl. No.: 18/192,254

(22) Filed: Mar. 29, 2023

Related U.S. Application Data
(63) Continuation of application No. PCT/JP21/36312, filed on Sep. 30, 2021.

(30) Foreign Application Priority Data
Sep. 30, 2020 (JP) 2020-165720

(51) Int. Cl. A41D 27/08; B41M 1/12

(52) U.S. Cl. CPC A41D 27/08; B41M 1/12; A41D 2600/10

(57) ABSTRACT

Issue

To make available clothing that supports the wearer's muscles to allow movement capacity to be improved in situations such as during sports, and that at the same time allows manufacturing costs to be reduced.

Resolution Means

Clothing 100 involving the present invention is furnished with an upper-body piece 10 for covering at least a portion of the upper half of the body, and upper-body support patternings 20 formed on the upper-body piece 10. The upper-body support patternings 20 include an upper-body first printed-on patterning 21 situated in sites following at least a portion of the psoas major muscles (901), an upper-body second printed-on patterning 22 situated in sites following the supraspinatus muscles (903), and an upper-body third printed-on patterning 23 situated in sites following the teres major muscles (904). The upper-body support patternings 20 are constituted from ink-impressed figures formed by ink being printed on the upper-body piece 10.

### TECHNICAL FIELD

The present invention relates to clothing. In particular, it relates to clothing (e.g., shirts, pants, skinsuits, etc.) that can support the wearer's muscles in situations including during sports, during heavy lifting, or being under nursing care.

The present application claims priority based on Japanese Patent Application No. 2020-165720, filed on Sep. 30, 2020; the entire content of the application is hereby incorporated into the present specification by reference.

### BACKGROUND ART

Athletic wear for improving athletic performance when sports and other athletic games are engaged in has become familiar in recent years. Needs in respect of athletic wear are apparently very deep-seated. To take the example of golf: users who think they would like to raise their club-head speed and extend their flight distance even without daily strength training and stretching have become an appreciably numerous presence (e.g., see Patent Document 1).

Also, not just in golf as discussed above—in all sorts of sports and exercise, such as tennis, baseball, swimming, and yoga—movement of the shoulder blades that accompanies pivoting of other faculties and motion of the arms is frequent. For example, in golf and tennis, when the club or racket is swung, right-left asymmetrical movement of the shoulder blades caused by pivoting of the trunk takes place, while with poses in yoga, bilateral-symmetrical movement of the shoulder blades caused by bilateral-symmetrical moving of both arms takes place.

Such movement of the shoulder blades is in most cases not either the right or left shoulder blade moving independently, but the right and left shoulder blades moving cooperatively. Nevertheless, with typical athletic clothes in any case doing nothing more than bracing the upper-body posture of the wearer by means of tensing areas that, with respect to a main body section having elasticity, have higher tensing force than the main body, sufficient consideration has not been given to cooperative movement of the left and right shoulder blades. Accordingly, with these typical athletic garments, sufficiently improving athletic performance in the variety of movements that accompany pivoting of the trunk and motion of the arms has been problematic.

Against this backdrop as such, in Patent Document 1, athletic wear 1000 as illustrated in FIG. 1 and FIG. 2 is disclosed. FIG. 1 and FIG. 2 are, respectively, a front side view and a rear side of the athletic wear 1000. The athletic wear 1000 is athletic wear that in the various movements accompanying pivoting of the trunk and motion of the arms enables athletic performance to be adequately improved.

The athletic wear 1000 is provided with a main body section 110 that fits closely to the upper half of the wearer's body, and tensing pieces 120 stitched into the outer sides of the main body section 110. The main body section 110 is composed of a front waist 111 and a rear waist 112, a collar section 113, and sleeve sections 114. The tensing pieces 120 are composed of, formed on the rear waist 112, first tensing sections 121, a second tensing section 122, and third tensing sections 123, and, formed on the front waist 111, fourth tensing sections 124. The first tensing sections 121 through fourth tensing sections 124, by their tensing force being caused to act, function to support the wearer's muscles and skeletal structure in the areas on which the first tensing sections 121 through fourth tensing sections 124 lie.

By means of the athletic wear 1000 when being worn, tensing force from the first tensing sections 121 acts on the shoulder blades and the muscle groups surrounding the shoulder blades, supporting in a spread-out manner the regions where the shoulder blades are mobile when the wearer performs pivoting of the trunk and movement of the arms. Meanwhile, tensing force from the first tensing section 121 on one side is transmitted via the second tensing section 122 to the first tensing section 121 on the other side. Therefore, movement of the shoulder blade on the other side cooperating with movement of the shoulder blade on the one side is boosted further, making the range though which the shoulder blades are mobile that much more broadened. Accordingly, with the athletic wear 1000, flexibility in and around the shoulders when the left and right shoulders move cooperatively is effectively heightened, enabling improvement to be realized in the performance of movements of every sort that accompany pivoting of the trunk and motion of the arms.

### PRECEDENT TECHNICAL LITERATURE

### Patent Documents

Patent Document 1: Japanese Patent No. 4061336
Patent Document 2: Japanese Patent No. 6409143

### SUMMARY OF INVENTION

### Issues Invention is to Resolve

According to the athletic wear 1000 described above, due to the action of first tensing sections 121 through fourth tensing sections 124, flexibility in and around the shoulders when the left and right shoulders move cooperatively is effectively heightened, improving the performance of movements of every sort that accompany pivoting of the trunk and motion of the arms. Nevertheless, bettering athletic performance is not just a matter of heightening flexibility in and around the shoulders. The applicants in the present application, based on approaches (concepts) that differ fundamentally from those to date, have disclosed in Patent Document 2 clothing (shirts, pants, etc.) for improving athletic performance.

While the clothing (shirts, pants, etc.) that the applicants in the present application disclosed in Patent Document 2 was clothing (shirts, pants, etc.) that can improve athletic performance extraordinarily, the inventors in the present application upon further study became aware of aspects including that the manufacturing costs are rather high, and that in ordinary daily activities, doing the laundry etc. could lead to the tape peeling off, wherein as a result of concerted investigative efforts, they hit upon novel clothing whereby those aspects may be bettered, bringing them to the present invention.

A principal object of the present invention, brought about taking such aspects into consideration, is in clothing that supports the wearer's muscles to enable improving capacity for and flexibility in movement in situations such as during sports, during heavy lifting, or being under nursing care, to make available clothing that enables reducing its manufacturing costs, and at the same time that despite being laundered or the like enables preventing tape from peeling off.

### Means for Resolving the Issues

Clothing involving the present invention—clothing for covering the body of a wearer—is furnished with an upper-body piece for covering at least a portion of the upper half of the body, and upper-body support patternings formed on the upper-body piece. The upper-body support patternings include an upper-body first printed-on patterning situated in a site following at least a portion of the psoas major muscle, an upper-body second printed-on patterning situated in a site following the supraspinatus muscle, and an upper-body third printed-on patterning situated in a site following the teres major muscle. The upper-body support patternings are constituted from ink-impressed figures formed by ink being printed on said upper-body piece.

In a preferred embodying mode, the upper body piece has the form of a T-shirt. The ink-impressed figures are formed by silkscreen printing. The upper-body first printed-on patterning is of 25 mm±10 mm width. The upper-body second printed-on patterning and the upper-body third printed-on patterning each are of 50 mm±10 mm width.

In a preferred embodying mode, the upper-body first printed-on patterning, the upper-body second printed-on patterning, and the upper-body third printed-on patterning each are disposed in a bilateral-symmetrical geometry.

Other clothing involving the present invention—clothing for covering the body of a wearer—is furnished with an upper-body piece for covering at least a portion of the upper half of the body, and upper-body support patternings formed on the upper-body piece. The upper-body support patternings include an upper-body second printed-on patterning situated in a site following the supraspinatus muscle, and an upper-body third printed-on patterning situated in a site following the teres major muscle. The upper-body support patternings are constituted from ink-impressed figures formed by ink being printed on said upper-body piece. The upper-body piece has the form of a T-shirt, and the ink-impressed figures are formed by silkscreen printing.

In a preferred embodying mode, the upper-body second printed-on patterning and the upper-body third printed-on patterning each are of 50 mm±10 mm width. The upper-body second printed-on patterning and the upper-body third printed-on patterning each are disposed in a bilateral-symmetrical geometry.

Still other clothing involving the present invention—clothing for covering the body of a wearer—is furnished with a lower-body piece for covering at least a portion of the lower half of the body, and lower-body support patternings formed on the lower-body piece. The lower-body support patternings include a lower-body first printed-on patterning situated in a site following at least a portion of the psoas major muscle, a lower-body second printed-on patterning situated in a site following the iliacus muscle, and a lower-body third printed-on patterning situated in a site following the piriformis muscle. The lower-body support patternings are constituted from ink-impressed figures formed by ink being printed on said lower-body piece.

In a preferred embodying mode, the lower-body piece has the form of shorts. The ink-impressed figures are formed by silkscreen printing. The lower-body first printed-on patterning, the lower-body second printed-on patterning, and the lower-body third printed-on patterning each are of 25 mm±10 mm width.

In a preferred embodying mode, the lower-body first printed-on patterning, the lower-body second printed-on patterning, and the lower-body third printed-on patterning each are disposed in a bilateral-symmetrical geometry.

In a preferred embodying mode, the lower-body support patternings further include a lower-body fourth printed-on patterning situated in sites following the glutei minimi, and a lower-body fifth printed-on patterning situated in sites following the sacrotuberous ligaments.

Yet other clothing involving the present invention—clothing for covering the body of a wearer—is furnished with upper and lower clothing core pieces for covering at a least a portion of the upper half of the body and at least a portion of the lower half of the body, and support patternings formed on the upper and lower clothing core pieces. The support patternings include a first printed-on patterning situated in a site following the psoas major muscle, a second printed-on patterning situated in a site following the iliacus muscle, an upper-body second printed-on patterning situated in a site following the supraspinatus muscle, an upper-body third printed-on patterning situated in a site following the tees major muscle, and a lower-body third printed-on patterning situated in a site following the piriformis muscle. The support patternings are constituted from ink-impressed figures formed by ink being printed on the upper and lower clothing core pieces.

In a preferred embodying mode, the support patternings further include a lower-body fourth printed-on patterning situated in sites following the glutei minimi, and a lower-body fifth printed-on patterning situated in sites following the sacrotuberous ligaments.

In a preferred embodying mode, the ink-impressed figures constituting the support patternings are formed by silkscreen printing. The ink-impressed figures are of 60 mm or less width.

A manufacturing method involving the present invention—a method of manufacturing support clothing for supporting a wearer's capacity for movement—includes a step of preparing an upper-body piece for covering at least a portion of the upper half of the body; and a step of forming, by silkscreen printing on at least one of an obverse side or a reverse side of the upper-body piece fabric, an upper-body first printed-on patterning situated in a site following at least a portion of the psoas major muscle, an upper-body second printed-on patterning situated in a site following the supraspinatus muscle, and an upper-body third printed-on patterning situated in a site following the teres major muscle.

In a preferred embodying mode, in the step of forming by silkscreen printing, a printing screen defining the upper-body first printed-on patterning to be of 25 mm±10 mm width, and the upper-body second printed-on patterning and the upper-body third printed-on patterning each to be of 50 mm±10 mm width is employed. In the printing screen, the regions defining the upper-body first printed-on patterning, the upper-body second printed-on patterning, and the upper-body third printed-on patterning each are disposed in a bilateral-symmetrical geometry.

Another manufacturing method involving the present invention—a method of manufacturing support clothing for supporting a wearer's capacity for movement—includes a step of preparing a lower-body piece for covering at least a portion of the lower half of the body; and a step of forming, by silkscreen printing on at least one of an obverse side or a reverse side of the lower-body piece fabric, a lower-body first printed-on patterning situated in a site following at least a portion of the psoas major muscle, a lower-body second printed-on patterning situated in a site following the iliacus muscle, and a lower-body third printed-on patterning situated in a site following the piriformis muscle.

In a preferred embodying mode, in the step of forming by silkscreen printing, further forming by silkscreen printing a lower-body fourth printed-on patterning situated in sites following the glutei minimi, and a lower-body fifth printed-on patterning situated in sites following the sacrotuberous ligaments is carried out.

### Effects of Invention

On an upper body piece for covering at least a portion of the upper half of the body, upper-body support patternings are formed, with the upper-body support patternings including an upper-body first printed-on patterning situated in a site following at least a portion of the psoas major muscle, an upper-body second printed-on patterning situated in a site following the supraspinatus muscle, and an upper-body third printed-on patterning situated in a site following the teres major muscle, thereby activating the muscles by supporting them, so that the Conception Vessel and Governing Vessel meridians can be made to flow spontaneously. As a result, the wearer's muscles are supported in situations such as during sports, during heavy lifting, or being under nursing care, enabling capacity for and flexibility in movement to be improved. What is more, the fact that the upper-body support patternings are constituted from ink-impressed figures formed by ink being printed on the upper-body piece enables manufacturing costs to be lowered compared with instances in which the upper-body support patternings are fashioned by means of a taping medium.

Furthermore, by comparison with taping-medium implementations, in which repeated laundering or the like could lead to the taping medium peeling off, ink-impressed figures can be made long-lasting, since with them there is no peeling-off of a taping medium.

In addition, by combining with clothing (lower body clothes) in which on a lower body piece for covering at least a portion of the lower half of the body, lower-body support patternings are formed—with the lower-body support patternings including a lower-body first printed-on patterning situated in a site following at least a portion of the psoas major muscle, a lower-body second printed-on patterning situated in a site following the iliacus muscle, and a lower-body third printed-on patterning situated in a site following the piriformis muscle—in the same way as with the upper half of the body, in the lower half of the body as well, the muscles are supported, activating them to enable the Conception Vessel and Governing Vessel meridians to be made to flow spontaneously. Also, the lower body third printed-on patterning situated in a site following the piriformis muscle facilitates maintaining one's up-and-down and front-and-back balance. What is more, the fact that the lower-body support patternings are likewise constituted from ink-impressed figures enables manufacturing costs to be lowered compared with instances in which the lower-body support patternings are fashioned by means of a taping medium, and meanwhile enables them to be made long-lasting.

### BRIEF DESCRIPTION OF DRAWINGS

FIG. 1 is a front-side view of conventional athletic wear 1000.

FIG. 2 is a rear-side of the conventional athletic wear 1000.

FIGS. 3A, 3B and 3C respectively are a front-side view, a lateral view, and a rear-side view of the skeleton of a human 900.

FIGS. 4A and 4B respectively are diagrams illustrating the musculature of a supraspinatus muscle 903 and a teres major muscle 904.

FIGS. 5A and 5B respectively are diagrams illustrating the skeleton of an animal 900A, and the human 900 assuming an on-all-fours pose.

FIG. 6 is a diagram illustrating the musculature of an iliacus muscle 902 and a psoas major muscle 901.

FIG. 7 is a diagram illustrating the musculature of a piriformis muscle 905.

FIG. 8 is a perspective view illustrating the front-side configuration of clothing (a shirt) 2000 disclosed in Patent Document 2.

FIG. 9 is a perspective view illustrating the rear-side configuration of the clothing (shirt) 2000 disclosed in Patent Document 2.

FIG. 10 is a perspective view illustrating the front-side configuration of clothing (pants) 2100 disclosed in Patent Document 2.

FIG. 11 is a perspective illustrating the rear-side configuration of the clothing (pants) 2100 disclosed in Patent Document 2.

FIG. 12 is a front-side view illustrating the configuration of clothing (a shirt) 100 involving a mode of embodying the present invention.

FIG. 13 is a rear-side view illustrating the configuration of the clothing (shirt) 100 involving the present-invention embodying mode.

FIG. 14 is a diagram for explaining the layout of upper-body support patternings 20 (22 and 23) in the shirt 100 involving the present-invention embodying mode.

FIG. 15 is a front-side view illustrating the configuration of clothing (pants) 200 involving a mode of embodying the present invention.

FIG. 16 is a rear-side view illustrating the configuration of the clothing (pants) 200 involving the present-invention embodying mode.

FIG. 17 is a rear-side view illustrating a modified example of the clothing (pants) 200 involving the present-invention embodying mode.

FIG. 18 is a table presenting experimental results of when clothing (100 and 200) involving modes of embodying the present invention was worn.

FIG. 19 is a table presenting experimental results of when clothing (2000 and 2100) disclosed in Patent Document 2 was worn.

FIG. 20 is a flowchart for explaining a method of manufacturing the clothing (shirt) 100 involving the mode of embodying the present invention.

FIG. 21 is a screen-printing device 90 for manufacturing the clothing (shirt) 100.

FIG. 22 is a printing screen 89 for printing upper-body support patternings 20 (21).

FIG. 23 is a printing screen 89 for printing upper-body support patternings 20 (22 and 23).

FIG. 24 is a front-side view illustrating a configuration, involving a mode of embodying the present invention, in which a shirt 100 and pants 200 are combined.

FIG. 25 is a rear-side view illustrating a configuration, involving the present invention embodying mode, in which the shirt 100 and the pants 200 are combined.

FIG. 26 is a perspective view illustrating the front-side configuration of clothing (a skinsuit) 400 involving a mode of embodying the present invention.

FIG. 27 is a perspective view illustrating the rear-side configuration of the clothing (skinsuit) 400 involving the present-invention embodying mode.

### MODES FOR EMBODYING INVENTION

Prior to an explanation of details of modes of embodying the present invention being made, clothing involving the present invention will be explained, as will particular circumstances under which techniques for movement capacity improvement (also, body functioning betterment) were discovered, and clothing of Patent Document 2 disclosed by the inventors in the present application as well.

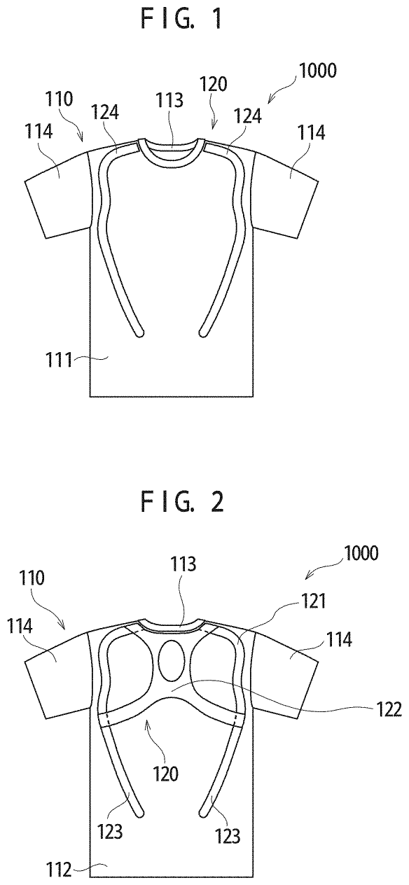

Upon concerted investigations into whether an ordinary T-shirt, not fancy athletic clothing 1000 such as is illustrated in FIG. 1 and FIG. 2, can be utilized to make physical functioning better, among the various investigations, upon affixing tape (therapeutic/fitness tape, as tape having just the right tension) to predetermined sites on a T-shirt, it was found to serve in the betterment of body functioning (movement capacity improvement).

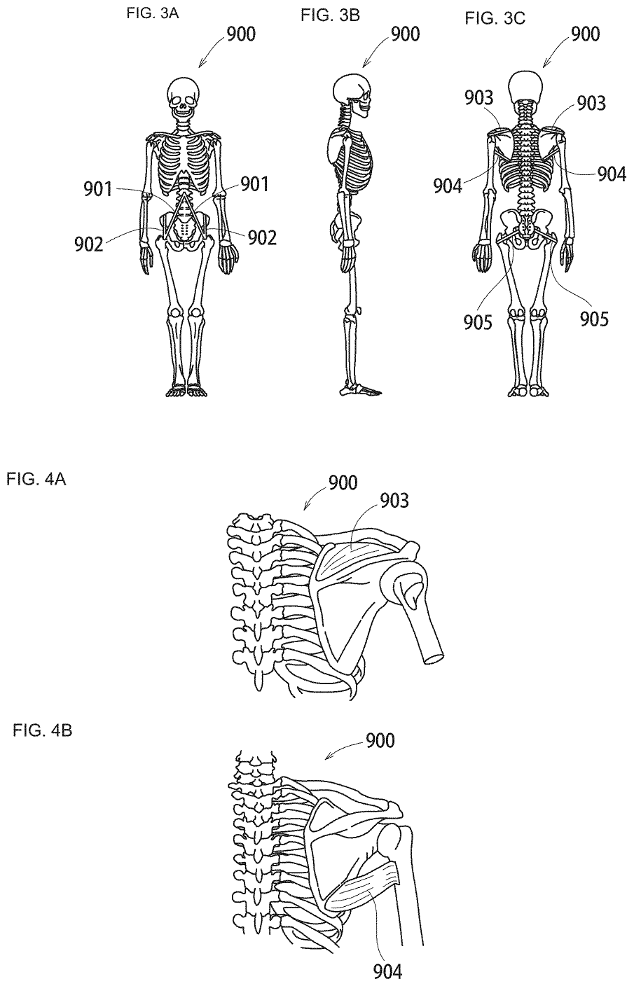

FIGS. 3A, 3B and 3C are a front-side view, lateral view, and back-side view of the skeleton of a human 900. The inventors in the present application affixed tape (commercial therapeutic/fitness tape) over the obverse of clothes (T-shirts as well as other shirts, and trousers). Specifically, they affixed tape (herein, gummed tape or therapeutic/fitness tape) in sites following the psoas major muscles 901, in sites following the iliacus muscles 902, in sites following the supraspinatus muscles 903, in sites following the teres major muscles 904, and in sites following the piriformis muscles 905. In doing so, they could see any number of improvements in physical capacity (including, for example, improvement in flexibility, and improvement in capacity for movement). Specifics of the improvement in physical capacity will be discussed later.

As to why affixing tape in these sites improves physical capacity, the precise reasons were not ascertained, but it was surmised that it may be something along the lines of the following, which is, however, not more than a hypothesis. The positions (901-905) where the tape is affixed are positions in the musculature corresponding to the meridians. The Conception Vessel (rèn mài) and Governing Vessel (dū mài), which pass through the very middle of a human being, may be cited as meridians of primary importance. The Conception Vessel, a radial vessel belonging to the Extraordinary Vessels, runs along the body's anterior median line. The Governing Vessel, likewise a radial vessel belonging to the Extraordinary Vessels, runs along the body's posterior median line.

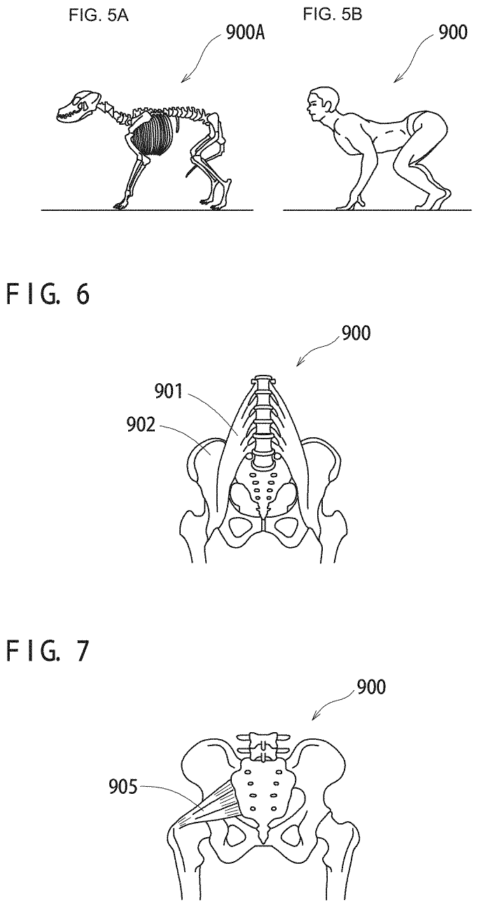

Herein, in the upper body half, the muscles that correspond to the Conception Vessel are the supraspinatus muscles 903, while the muscles that correspond to the Governing Vessel are the teres major muscles 904. FIGS. 4A and 4B respectively illustrate the musculature of a supraspinatus muscle 903 and a teres major muscle 904. Therein it is theorized that affixing tape to clothing where it corresponds to these muscles (903 and 904) can be an assist whereby the muscles are activated, so that as a result the meridians of the Conception Vessel and the Governing Vessel flow spontaneously. Further, the inventors in the present application deduced to where in the body lower half (the legs) do muscles having action like this correspond. FIGS. 5A and 5B are, respectively, diagrams of the skeleton of an animal 900A, and of the human 900 assuming an on-all-fours pose.

From there, likening the upper body to the forelegs and likening the lower body to the hindlegs presumably leads to correspondences as follows. Namely, the shoulder blades (upper body) correspond to the ilia (lower body); the shoulder joints (upper body), to the hip joints (lower body); the elbows (upper body), to the knees; and the wrists (upper body), to the ankles (lower body). Thus, in the lower body (hindlegs), what corresponds to the supraspinatus muscles 903 and the teres major muscles 904 are respectively the iliacus muscles 902 and the psoas major muscles 901. FIG. 6 illustrates the musculature of an iliacus muscle 902 and a psoas major muscle 901. Affixing tape in these sites can lend the sensation of an axis passing through the very middle of the body (the Conception Vessel and Governing Vessel). To liken this: In the martial arts, in situations in which techniques are applied not relying on power but only feel, the state may be thought of as the balance among emotions, thoughts, and the corporeal body being in order, and in such an ordered state, when nursing care is attempted it can be possible to lift a patient up lightly without using much power; wherein what is embodied by means of the technique according to which tape is affixed to the given sites is imagined to resemble a state of this sort.

In addition, when tape is applied to the iliacus muscles 902 and psoas major muscles 901 (the two together will also at times be referred to as the “iliopsoas muscle”) the formation of the body's axis will arise, yet the sense of being tugged by an attractive force could prove strong (for example, if one jumps, strongly feeling the force of landing). As a way of dealing with that, the idea of fixing tape onto sites of the piriformis muscles 905 was hit upon. FIG. 7 illustrates the musculature of a piriformis muscle 905. It was recognized that by addedly applying tape to the piriformis muscles 905, maintaining one's up-and-down and front-and-back balance is facilitated.

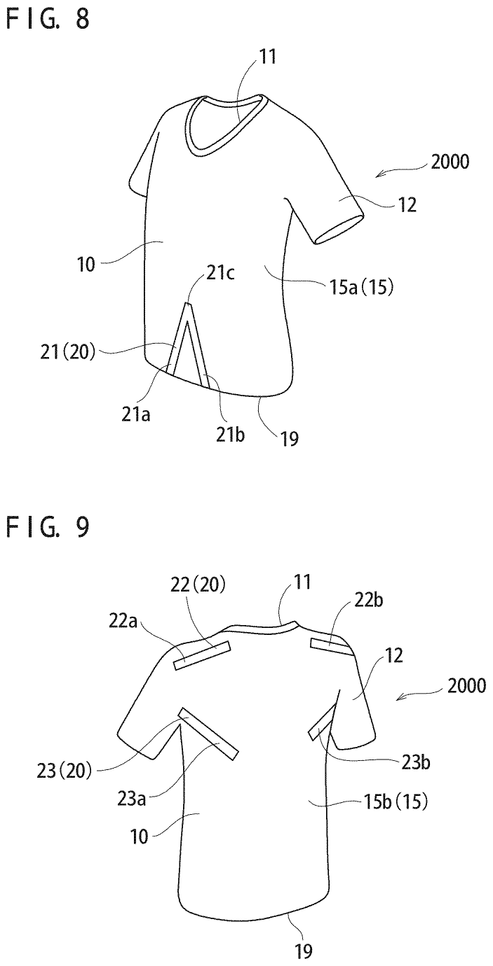

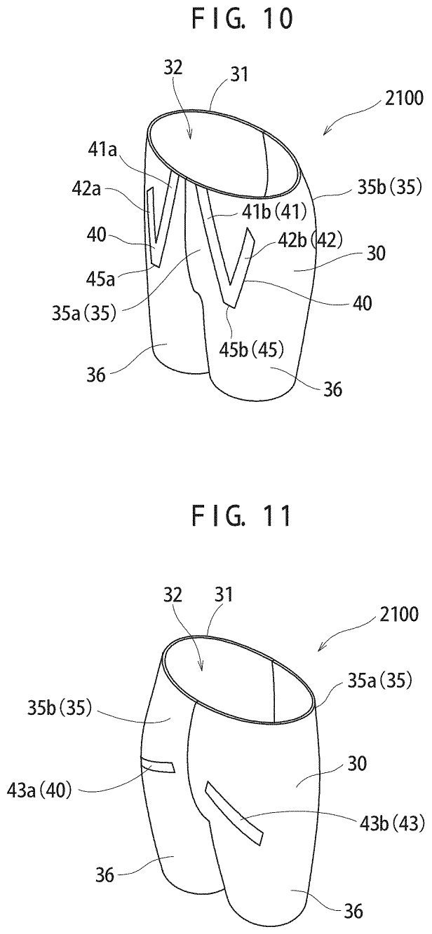

Next, while referring to FIG. 8 through FIG. 11, a description of the clothing (shirt, pants, etc.) that the inventors in the present application disclosed in Patent Document 2 will be made. FIG. 8 and FIG. 9 illustrate the front-side configuration and the back-side configuration of the clothing (shirt) 2000 disclosed in Patent Document 2. Likewise, FIG. 10 and FIG. 11 illustrate the front-side configuration and the back-side configuration of the clothing (pants) 2100 disclosed in Patent Document 2.

The shirt (T-shirt) 2000 illustrated in FIG. 8 and FIG. 9 is furnished with an upper-body piece 10 for covering the upper half of the body, and an upper-body support unit 20 formed on the upper-body piece 10. The upper body support unit 20 includes an upper-body first support section 21 situated in sites following at least a portion of the psoas major muscles (901), an upper-body second support section 22 situated in sites following the supraspinatus muscles (903), and an upper-body third support section 23 situated in sites following the teres major muscles (904).

The upper-body first support section 21 is constituted from a pair of structures of oblong form (strip pieces) 21a and 21b that extend along a portion of the psoas major muscles (901). The pair of strip pieces 21a and 21b extend downward from a point 21c that corresponds to the location that is the starting point of the upper end of the psoas major muscles. The upper-body second support section 22 is constituted from a pair of structures of oblong form (strip pieces) 22a and 22b that extend along the supraspinatus muscles (903). The upper-body third support section 23 is constituted from a pair of structures of oblong form (strip pieces) 23a and 23b that extend along the teres major muscles (904). In one preferred example of the shirt 2000, the upper-body first support section 21, the upper-body second support section 22, and the upper-body third support section 23 are constituted from a taping medium. The upper-body first support section 21, the upper-body second support section 22, and the upper-body third support section 23 lend the muscles a sense of tape (or cloth) having been applied to the sites of the given muscles (901, 903, and 904) on the shirt 2000, imparting stimuli to the given muscles (901, 903, and 904) and activating, and thereby enabling an assist to, the muscles. Also, when the upper-body first support section 21, the upper-body second support section 22, and the upper-body third support section 23 are constituted from a taping medium, in order that they not come off during laundering or the like, it is preferable to fix them with iron-on adhesive and then attach them securely by sewing them in with thread.

Likewise, the pants (breeches) 2100 illustrated in FIG. 10 and FIG. 11 are furnished with a lower-body piece 30 for covering the lower half of the body. The lower-body piece 30 is constituted from a waist section 31 that defines an opening 32 through which the trunk enters, an above-crotch section 35 that clothes the lower-body trunk (the area around the abdomen and the groin), and below-crotch sections 36 that cover the legs. In the pants 2100, a lower-body support unit 40 is formed on the lower-body piece 30. The lower-body support unit 40 is constituted from: a lower-body first support section 41 situated in sites following at least a portion of the psoas major muscles (901); a lower-body second support section 42 situated in sites following the iliacus muscles (902); and a lower-body third support section 43 situated in sites following the piriformis muscles (905).

The lower-body first support section 41 is constituted from a pair of structures of oblong form (strip pieces) 41a and 41b that extend along a portion of the psoas major muscles (901). The pair of strip pieces 41a and 41b extend upward from points 45 (45a and 45b) that correspond to the locations that are the starting points of the lower ends of the psoas major muscles. The lower-body second support section 42 is constituted from a pair of structures of oblong form (strip pieces) 42a and 42b that extend along the iliacus muscles (902). The lower-body third support section 43 is constituted from a pair of structures of oblong form (strip pieces) 43a and 43b that extend along the piriformis muscles (905). In one preferred example of the pants 2100, the lower-body first support section 41, the lower-body second support section 42, and the lower-body third support section 43 are constituted from a taping medium. The lower-body first support section 41, the lower-body second support section 42, and the lower-body third support section 43, lend the muscles a sense of tape (or cloth) having been applied to the sites of the given muscles (901, 903 and 905) on the pants 2100, imparting stimuli to the given muscles (901, 903, and 905) and activating, and thereby enabling an assist to, the muscles. Here, in the same way as with the upper-body support sections (21 to 23), when the lower-body first support section 41, the lower-body second support section 42, and the lower-body third support section 43 are constituted from a taping medium, in order that they not come off during laundering or the like, it is preferable to fix them with iron-on adhesive and then attach them securely by sewing them in with thread.

According to the clothing (shirt) 2000 disclosed in Patent Document 2, since on an upper-body piece 10 for covering at least a portion of the upper half of the body, the upper-body support unit 20 is formed, with the upper-body support unit 20 including the upper-body first support section 21 situated in a site following at least a portion of the psoas major muscles (901), the upper-body second support section 22 situated in a site following the supraspinatus muscles (903), and the upper-body third support section 23 situated in a site following the teres major muscles (904), the muscles are supported, whereby they are activated, enabling the meridians of the Conception Vessel and the Governing Vessel to be made to flow spontaneously. As a result, the wearer's muscles (or otherwise, entire body, including the muscles and joints, etc.) are supported in situations such as during sports, during heavy lifting, or being under nursing care, making improved movement capacity and flexibility possible. Meanwhile, combining with clothing (lower body clothes) 2100 in which on the lower-body piece 30 for covering at least a portion of the lower half of the body, the lower-body support unit 40 is formed—with the lower-body support unit 40 including the lower-body first support section 41 situated in a site following at least a portion of the psoas major muscles (901), a lower-body second support section 42 situated in a site following the iliacus muscles (902), and the lower-body third support section 43 situated in a site following the piriformis muscles (905)—in the same way as with the upper half of the body, in the lower half of the body as well, enables the muscles to be supported, activating them to make the meridians of the Conception Vessel and the Governing Vessel flow spontaneously. Also, the lower-body third support section 43 situated in a site following the piriformis muscles (905) facilitates maintaining one's up-and-down and front-and-back balance. Meanwhile, in Patent Document 2 numerous data appear that indicate improvements in movement capacity and flexibility.

In Patent Document 2, it is disclosed that as long as regions that are “areas that support” can be formed by the upper-body support unit 20 (21, 22, and 23) and/or the lower-body support unit 40 (41, 42, and 43), the upper-body support unit 20 (or 40) is not limited to being a taping medium, in that the material or weave of the upper-body piece 10 constituting the shirt 2000 may be changed, or inside the textile constituting the upper-body piece 10, a medium/component capable of making the “areas that support” may be disposed. Meanwhile, the inventors in the present application did a series of further research and experiments on methods of forming, without limiting to taping media, the regions being the “areas that support” that are disclosed in Patent Document 2. Amongst those, upon forming an upper-body support unit 20 (21, 22, and 23) by silk screen printing (or silk printing) in which ink was directly printed into the fabric of clothing (e.g., T-shirt fabric), they perfected being able to fabricate articles that demonstrate the same capabilities as the those having an upper-body support unit 20 (21, 22, and 23) constituted from a taping medium, bringing them to the present invention.

Hereinafter, referring to the drawings, an explanation of preferred modes of embodying the present invention will be made. Below in the drawings, for the sake of making the explanation concise, elements and regions exhibiting the same actions are labeled with the same reference marks, and reduplicating description in some instances will be either omitted or abbreviated. Furthermore, in every diagram the dimensional relationships (length, width, thickness, etc.) in some cases do not necessarily reflect the actual dimensional relationships accurately. Nevertheless, some dimensional relationships in designated drawings have been made coincident, and in those cases, from the dimensional and positional relationships in each diagram it is possible to derive the six primary views. It will be appreciated that inasmuch as the subject is clothing (clothes) thickness in the six primary views often may be ignored.

Further, particulars that are necessary for implementing the present invention and are matters apart from the particulars specifically referred to in the present specification can be apprehended to be particulars of design for the person skilled in the art, based on conventional technology in the given field. The present invention can be implemented based on the content disclosed by the present specification and drawings, and on common technical knowledge in the given field. What is more, the present invention is not limited to the following embodying modes.

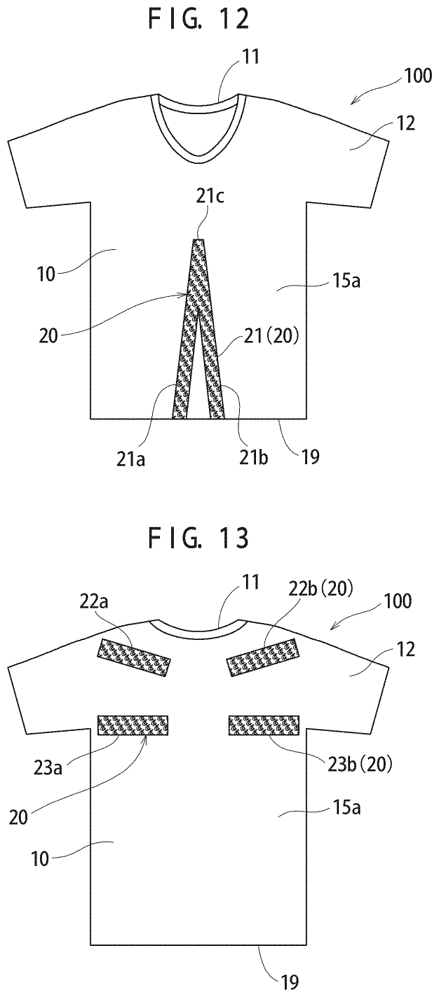

FIG. 12 and FIG. 13 respectively illustrate the front side configuration and the rear side configuration of clothing (a shirt) 100 involving a mode of embodying the present invention. The clothing 100 of the present embodying mode is clothing for covering the body of a wearer and has the configuration of a shirt (the illustrated example being a T-shirt). It should be noted that the shirt 100 of the present embodying mode shares basic elements with the shirt 2000 illustrated in FIG. 8 and FIG. 9, wherein accordingly, the explanation sometimes will overlap, or otherwise often may be understood from what was explained with the shirt 2000. For convenience's sake, the elements that are in common are to the extent possible are described labeled with the same reference marks so that the explanation will be easier to understand. Meanwhile, the major difference from the upper-body support units 20 in the shirts 2000 illustrated in FIG. 8 and FIG. 9 is in that in the shirt 100 of the present embodying mode, they are impressed figures formed by ink being printed on the fabric of the shirt (T-shirt).

The shirt 100 of the present embodying mode is furnished with an upper-body piece 10 for covering at least a portion of the upper half of the body. In the configuration of the present embodying mode, the upper-body piece 10 constituting the shirt 100 is made up of a trunk portion 15, consisting of a front waist 15a and a rear waist 15b, and a collar section 11 and sleeve sections 12. In this example, the lower edge 19 of the trunk portion 15 is situated along the periphery of the loins or the groin. Since the shirt 100 (upper-body piece 10) of the present embodying mode is in the form of a T-shirt, the collar section 11 is round-necked and not a collar such as is on ordinary shirts (e.g., dress shirts), but there may be a collar. Likewise, the sleeve sections 12 are short sleeves, but the shirt may be of such morphology as long-sleeved, three-quarter-sleeved (or elbow-length-sleeved), or sleeveless. While a trunk portion 15 in which a front waist 15a and a rear waist 15b are stitched together is readily fashioned, it may equally well be a seamless, unitary item.

The material constituting the upper-body piece 10 of the present embodying mode is fabric that is typically employed as clothing, and that as clothing has suitable stretchability. It should be understood that stretchability herein means what as clothing is a suitable property, not what especially demands the restorative capability of rubber (elastomers). Examples that can be cited of the material (fabric) constituting the shirt 100 (upper-body piece 10) are: natural-fiber textiles (e.g., cotton fiber (cottons), silk fiber (silks), etc.), and synthetic fiber textiles (e.g., polyester fiber, etc.), as well as textiles blended from natural-fiber textiles and synthetic-fiber textiles (e.g., polyester and cotton mixed yarns, etc.), and blended textiles of a plurality of kinds (e.g., nylon-polyurethane fiber, rayon fiber-acrylic fiber-polyester fiber, acrylic fiber-polyester fiber-rayon fiber-polyurethane fiber, etc.). In the illustrated shirt (T-shirt) 100, the material constituting the upper-body piece 10 is cotton (cotton fiber).

In the clothing (shirt) 100 of the present embodying mode, the upper-body support patternings 20 are formed on the upper-body piece 10 (or on the material constituting the upper-body piece 10—herein, on the material (cotton) constituting the T-shirt). In the configuration of the present embodying mode, the upper-body support patternings 20 are constituted from an upper-body first printed-on patterning 21 situated in sites following at least a portion of the psoas major muscles (“901” in FIG. 3A), an upper-body second printed-on patterning 22 situated in sites following the supraspinatus muscles (“903” in FIG. 3C), and an upper-body third printed-on patterning 23 situated in sites following the teres major muscles (“904” in FIG. 3C).

The upper-body first printed-on patterning 21 of the present embodying mode is constituted from, as illustrated in FIG. 12, a pair of structures of oblong form (strip pieces) 21a and 21b that extend along a portion of the psoas major muscles (901). The pair of strip pieces 21a and 21b extend downward from a point 21c that corresponds to the location that is the starting point of the upper end of the psoas major muscles. In the example illustrated in FIG. 12, the pair of strip pieces 21a and 21b do not extend as far as the lower end of the psoas major muscles. Nevertheless, the upper-body piece 10 may be lengthened downward, and the pair of strip pieces 21a and 21b may be further extended downward so as to follow the entirety of the psoas major muscles.

The upper-body second printed-on patterning 22 of the present embodying mode is constituted from, as illustrated in FIG. 13, a pair of structures of oblong form (strip pieces) 22a and 22b that extend along the supraspinatus muscles (903). Being that the strip pieces 22a and 22b extend along the supraspinatus muscles (903), preferably they are formed to extend from end to end along (from the start point to the end point of) the supraspinatus muscles. And while depending on the wearer's figure there will be cases where they are not formed to follow the entirety of the supraspinatus muscles (903), to the extent possible they preferably are created putting together a lineup of sizes (or otherwise are made to order) in forms such that the one end and the other end (the start point and the end point (or the origin area and the terminal area)) of the supraspinatus muscles may correspond to the start point and the end point of the strip pieces 22a and 22b. While in the example illustrated in FIG. 13, the strip pieces 22a and 22b assume a “V” shape following the supraspinatus muscles (903), they may be made extending in parallel, as long as they follow the supraspinatus muscles (903).

The upper-body third printed-on patterning 23 of the present embodying mode is constituted from, as illustrated in FIG. 13, a pair of structures of oblong form (strip pieces) 23a and 23b that extend along the teres major muscles (904). Being that the strip pieces 23a and 23b extend along the teres major muscles (904), preferably they are formed to extend from end to end along (from the start point to the end point of) the tees major muscles. And while depending on the wearer's figure there will be cases where they are not formed to follow the entirety of the teres major muscles (904), to the extent possible they preferably are created putting together a lineup of sizes (or otherwise are made to order) in forms such that the one end and the other end (the start point and the end point) of the teres major muscles may correspond to the start point and the end point of the strip pieces 23a and 23b.

In the present embodying mode, the upper-body support patternings 20 (specifically, the upper-body first printed-on patterning 21, the upper-body second printed-on patterning 22, and the upper-body third printed-on patterning 23) are constituted from ink-impressed figures formed by ink being printed on. That is, the upper-body support patternings 20 (21, 22, and 23) are formed, rather than with a taping medium in what was disclosed as one of preferred examples in Patent Document 2, by printing. In a preferred example of the present embodying mode, the ink-impressed figures constituting the upper-body support patternings 20 are formed by silkscreen printing.

Silk screen printing (screen printing and silk printing), a type of stencil printing, is a technique in which apertures (pores) are made in a mesh-like screen, and to print ink is cast only into the aperture areas. Its origins are in the fact that in the past, the screens were made of silk, but with screens of mesh form today, owing to durability issues, cloth of synthetic fiber such as polyester or nylon (there can be metal instances too) instead of silk is employed as the mesh medium for stencil prints. In the silkscreen printing, the mesh in a made-up screen and the shirt fabric (in this case, cotton) are brought into close contact, after which ink is placed on the mesh in the made-up screen, and next a squeegee is pressed hard against the top of the mesh and moved in a fixed direction across the entire surface of the mesh (or designated locations where printing is desired), whereby printing is executed by ink being pressed through the holes in the mesh and out onto the fabric. It should be noted that, inasmuch as silkscreen printing technology is general with T-shirt printing, it is not special technology; therefore, while from a technical aspect it has a high degree of stability, it enables production costs to be lowered.

Examples that can be cited as inks for T-shirt printing in silkscreen printing are: plastisol (ink), and water-based rubber (ink). In factories that carry out large-volume printing (large-lot projects of 300-plus runs) plastisol is often used, while in factories of medium scale (small-lot projects on the order of 50 runs) water-based rubber is often used. It will be appreciated that with the clothes (shirt 100) of the present embodying mode, silkscreen printing is employed, but as long as the effectiveness of clothes (shirt 100) of the present embodying mode can be obtained, other printing (e.g., inkjet direct printing, etc.) may be employed. Also, the printing ink (ink for shirt printing) of the present embodying mode is compounded with minerals (powders). In one example, the printing ink of the present embodying mode is adjusted to a concentration at which minerals (minerals that are known as so-called power stones (e.g., radium ore, germanium, quartz, “terahertz ore,” tourmaline, etc.), or a blend of several kinds of minerals) of 325-mesh particle size (about 44 microns)—per 500 square centimeters of ink, appropriate amounts from among 0.1 g to 0.5 g of each kind (in one example, one, two, or three kinds)—are compounded. It will be appreciated that 500 square centimeters of ink is a surface area equivalent to the print surface area on one shirt. It will also be appreciated that this concentration is merely one example, and can be changed or adjusted to what is suitable and appropriate to accord with the conditions under which it is used. Furthermore, additives other than minerals (powders) may equally well be included. A mineral powder of at least one kind (or a blended mineral powder of two or more kinds) selected from the group consisting of radium ore, germanium, quartz, terahertz ore, and tourmaline can be utilized as the mineral powder.

In the configuration of the present embodying mode, the ink-impressed figures constituting the upper-body support patternings 20 being fashioned by silkscreen printing produces differences in tactile and other properties (difference in texture, with the softness, stretchability, surface smoothness, and other material properties being different) between the T-shirt fabric (cotton) area and the areas that are printed onto (the upper-body support patternings 20), with the differences in properties activating the muscles to assist capacity for movement. It will be appreciated that even if the differences in properties are slight, since it suffices that the ink-impressed figures (upper-body support patternings 20), rather than support muscles and other parts of the body to fulfill the function of improving capacity for movement, are a trigger of muscle stimulation (where the body is a mass of delicate sensors), even with the differences in properties due to presence of the ink-impressed figures being slight, effectiveness in improving capacity for movement can be demonstrated. It should be noted that in instances in which minerals are compounded into the ink, there can be a possibility that impact from the minerals (e.g., negative ions, terahertz waves, static electricity, far infrared rays, hormesis, etc.) proves to be a stimulant to the muscles. In one example of the present embodying mode, ink-impressed figures constituting the upper-body support patternings 20 are formed on the obverse side (exposed surface) of the upper-body piece 10 to construct the upper-body first printed-on patterning 21, the upper-body second printed-on patterning 22, and the upper-body third printed-on patterning 23. By the same token, ink-impressed figures (upper-body support patternings 20) can be formed on the reverse side (surface along the body) of the upper-body piece 10 to construct the upper-body first printed-on patterning 21, the upper-body second printed-on patterning 22, and the upper-body third printed-on patterning 23.

The upper-body first printed-on patterning 21, the upper-body second printed-on patterning 22, and the upper-body third printed-on patterning 23 of the present embodying mode each are of, for example, 60 mm or less width. In the illustrated example, the upper-body first printed-on patterning 21 is of 25 mm(±10 mm) width. Meanwhile, the upper-body second printed-on patterning 22 and the upper-body third printed-on patterning 23 each are of 50 mm(±10 mm) width. Although with the upper-body first to third printed-on patternings 21 to 23 being of small width, (e.g., with the upper-body first printed-on patterning 21, 10 mm, and with the upper-body second and third printed-on patterning (22 and 23), 25 mm) allows them to be applied to the corresponding muscles with pinpoint accuracy to create overall balance, considering differences in each individual's figure (especially when mass production is involved), one preferred approach would be to have the ink-impressed figures (the upper-body support patternings 20 and the upper-body first to third printed-on patternings 21 to 23) be of a bit wider width (50 mm (±10) mm and 25 mm (±10 mm)). It is to be noted that in order that stimulation to the muscles (muscle activation) not be dulled, making the width 60 mm or less (preferably, 50 mm or less, or 50 mm) is satisfactory, but since what is appropriate varies depending on the individual, there could be cases in which the width would be made comparatively large (e.g., 50 mm to 100 mm).

In a configuration of the present embodying mode, the upper-body first printed-on patterning 21, the upper-body second printed-on patterning 22, and the upper-body third printed-on patterning 23 each can be made the same width (e.g., 50 mm). Alternatively, the upper-body second printed-on patterning 22 and the upper-body third printed-on patterning 23 may equally well be made differing widths, rather than the same width. This is because by varying the width of the upper-body first printed-on patterning 21, the width of the upper-body second printed-on patterning 22, and the width of the upper-body third printed-on patterning 23, there will be a possibility that the movements of the different muscles can be further activated depending on the individual, and at the same time because there can be instances in which owing to the demands of design it is better that the widths be altered. In the present embodying mode, the width of the upper-body first printed-on patterning 21 is made half the width of the upper-body second printed-on patterning 22 and the width of the upper-body third printed-on patterning 23.

Since the human body (skeleton and muscles) is basically bilaterally symmetrical, the upper-body first printed-on patterning 21, the upper-body second printed-on patterning 22, and the upper-body third printed-on patterning 23 each are disposed in a bilateral-symmetrical geometry. In reality, however, the roles of the muscles on the right side and the left side can be different (for example, in a right-handed person, muscles for throwing, etc. with the right hand are developed), and in that respect, there are instances in which it is preferable, in line with (tailored to) each individual, to dispose the upper-body first printed-on patterning 21, the upper-body second printed-on patterning 22, and the upper-body third printed-on patterning 23 bilaterally asymmetrical, following the courses of the muscles on the right side and on the left side. In addition, when there is a situation in which for reasons such as the demands of design—as opposed to right-left differences (subtle differences in each individual) in location of the muscles—rendering a not bilaterally symmetrical disposition is desired, making changes within the range in which the upper-body support patternings 20 in the present embodying mode exhibit their functionality is possible. Further, for upper-body support patternings 20 in the present embodying mode, it is preferable to render the upper-body support patternings 20 with the end portions being at either side (the origin area as well as the terminal area) of the given muscles; but in cases where, owing to reasons including the demands of design, altering their form is desired, making changes within the range in which the upper-body support patternings 20 in the present embodying mode exhibits its functionality is possible.

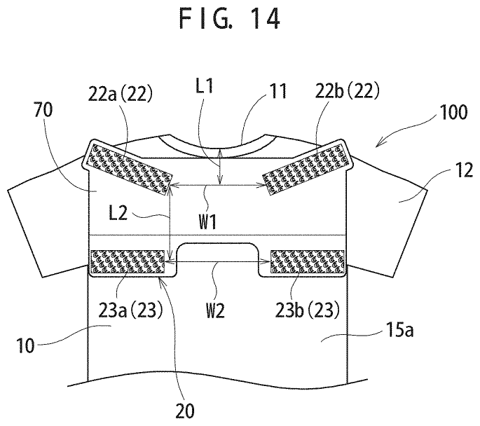

FIG. 14 illustrates a printing stencil sheet 70 that shows the pattern layout of upper-body support patternings 20 on the rear side of the shirt 100 of the present-invention embodying mode. On the printing stencil sheet 70, as the upper-body support patternings 20, the pattern layouts of the upper-body second printed-on patterning 22 (22a and 22b) and the upper-body third printed-on patterning 23 (23a and 23b) are inked. The pattern layout of this printing stencil sheet 70 is transferred to a silkscreen-printing screen (printing screen with a mesh area), which in the silkscreen printing then completes printing of the given pattern layouts (figure creation). It will be appreciated that the figure in this given illustrated pattern layout is an example, and equally well may be something else, or an unfigured pattern. In this example, the distance (vertical spacing) L1 from the opening around the neck is 80 mm (or 85 mm). The distance (vertical spacing) L2 in the central location between the upper-body second printed-on patterning 22 (22a and 22b) and the upper-body third printed-on patterning 23 (23a and 23b) is 135 mm (or 125 mm). The spacing (widthwise spacing) W1 between the upper-body second printed-on patterning 22 (22a and 22b) is 100 mm. Meanwhile, the spacing (widthwise spacing) W2 between the upper-body third printed-on patterning 23 (23a and 23b) is 140 mm. It will be appreciated that these numbers are examples; they will vary depending on the size of the shirt 100, and when it is custom-made, they will vary depending on the individual's figure.

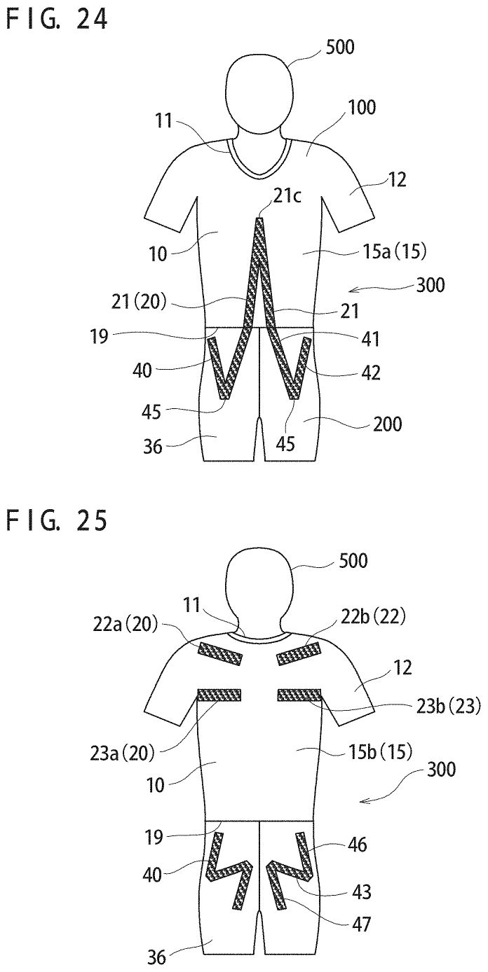

Now, a shirt 100 of the present embodying mode can be modified as follows. Disclosed and descriptively illustrated in FIG. 24 of Patent Document 2, a shirt 100 of the present embodying mode despite not being formed with the upper-body first printed-on patterning 21 situated in sites following a portion of the psoas major muscles (901), because it nonetheless is formed with the upper-body second printed-on patterning 22 situated in sites following the supraspinatus muscles (903), and the upper-body third printed-on patterning 23 situated in sites following teres major muscles (904), it supports these muscles (903 and 904), thereby activating them to enable the meridians of the Conception Vessel and the Governing Vessel to be made to follow spontaneously, thanks to which the shirt therefore has beneficial effects. Accordingly, as a modified example, instances in which a shirt 100 of the present embodying mode is formed with an upper-body first printed-on patterning 21 are preferable in terms of stability and improvement capacity for movement (for example, there will be cases where differences including that post-exercise fatigue appears less are evident).

A shirt 100 of the present embodying mode can be further modified as follows. Disclosed and descriptively illustrated in FIG. 34 of Patent Document 2, a shirt 100 of the present embodying mode, in addition to the upper-body first printed-on patterning 21 (21a and 21b) located on the front side, can be formed with an additional upper-body support patterning (not illustrated). The additional upper-body support patterning (reference mark “21e” in FIG. 34 of Patent Document 2, incidentally) is disposed, wherein with the site of the solar plexus being made a reference a point shifted toward a location on the left ribs is the starting point, extending from there to an infraumbilical site. By and large, the solar plexus is in a spot about three fingers below the navel. The angle at which the additional upper-body support patternings extend (the angle at which it extends inclined) is, with a perpendicular line as a reference, 20° to 25° (in one example, approximately 23° (23.4°)). By the forming of the additional upper-body support patternings, the body's rotation will be greater. Forming the additional upper-body support patternings increases the angle of rotation along the horizontal and is therefore suited to playing golf.

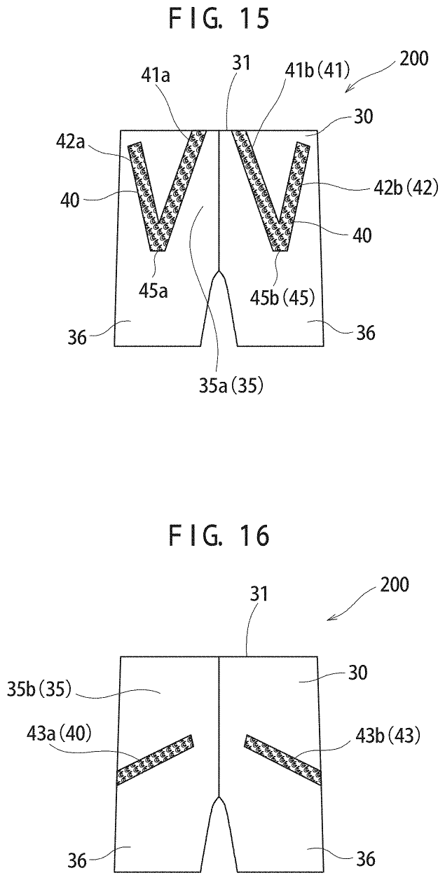

FIG. 15 and FIG. 16 respectively illustrate the front side configuration and the rear side configuration of clothing (pants, trousers, or tights) 200 involving a mode of embodying the present invention. Clothing 200 of the present embodying mode is clothing for covering the body of a wearer, and has the configuration of trousers (in the illustrated example, breeches).

Clothing (pants, or crotched clothing) 200 of the present embodying mode is furnished with a lower-body piece 30 for covering at least a portion of the lower half of the body. In the configuration of the present embodying mode, it is constituted from a waist section 31 that defines an opening 32 through which the trunk (principally, the abdomen and loins) enters, an above-crotch section 35 that clothes the lower-body trunk (the area surrounding the abdomen and the groin), and a below-crotch section 36 that covers the legs. Since the pants 200 (lower-body piece 30) of the present embodying mode have the form of breeches (shorts), the length of the below-crotch section 36 is short, but the below crotch section 36 may be as far as the ankles (or the knees or the shins). Further, pants 200 of the present embodying mode may be in the form of briefs without portions that cover the legs, or also may be a swimsuit. Still further, with the illustrated pants 200, a mode in which the fabric on the right and left are joined together is represented, but the mode may be one in which the front waist 35a and the rear waist 35b of the pants 200 are joined together, as well as a mode in which the trousers are assembled with other parts; it is not limited to the illustrated specific configurations.

The material constituting the lower-body piece 30 of the present embodying mode is fabric typically employed as clothing, and has suitable stretchability as clothing. It should be understood that stretchability herein means what as clothing is a suitable property, not what especially demands the restorative capability of rubber (elastomers). Examples that can be cited of the material (fabric) constituting the pants 200 (lower-body piece 30) are: natural-fiber textiles (e.g., cotton fiber (cottons), silk fiber (silks), etc.), and synthetic fiber textiles (e.g., polyester fiber, etc.), as well as textiles blended from natural-fiber textiles and synthetic-fiber textiles (e.g., polyester and cotton mixed yarns, etc.), and blended textiles of a plurality of kinds (e.g., nylon-polyurethane fiber, rayon fiber-acrylic fiber-polyester fiber, acrylic fiber-polyester fiber-rayon fiber-polyurethane fiber, etc.).

In the clothing (pants) 200 of the present embodying mode, on the lower-body piece 30 (or on the material constituting the lower body piece 30—herein, on the material constituting the breeches) lower-body support patternings 40 are formed. In the configuration of the present embodying mode, the lower-body support patternings 40 are constituted from a lower-body first printed-on patterning 41 situated in sites following at least a portion of the psoas major muscles (“901” in FIG. 3A), a lower-body second printed-on patterning 42 situated in sites following the iliacus muscles (“902” in FIG. 3A), and a lower-body third printed-on patterning 43 situated in sites following the piriformis muscles (“905” in FIG. 3C).

The lower-body first printed-on patterning 41 of the present embodying mode is constituted from, as illustrated in FIG. 15, a pair of structures of oblong form (strip pieces) 41a and 41b that extend along a portion of the psoas major muscles (901). The pair of strip pieces 41a and 41b extend upward from points 45 (45a and 45b) that correspond to the location that is the starting point of the bottom end of the psoas major muscles. In the example illustrated in FIG. 15, the pair of strip pieces 41a and 41b do not extend as far as the upper end of the psoas major muscles. Nevertheless, the lower-body piece 30 may be lengthened upward, and the pair of strip pieces 41a and 41b may be further extended upward so as to follow the entirety of the psoas major muscles.

The lower-body second printed-on patterning 42 of the present embodying mode is constituted from a pair of structures of oblong form (strip pieces) 42a and 42b that extend along the iliacus muscles (902). Being that the strip pieces 42a and 42b extend along the iliacus muscles (902), preferably they are formed to extend from end to end along (from the start point to the end point of) the supraspinatus muscles. And while depending on the wearer's figure there will be cases where they are not formed to follow the entirety of the iliacus muscles (902), to the extent possible they preferably are created putting together a lineup of sizes (or otherwise are made to order) in forms such that the one end and the other end (the start point and the end point (or the origin area and the terminal area)) of the iliacus muscles may correspond to the start point and the end point of the strip pieces 42a and 42b. What is more, in the configurations of the present embodying mode, what is illustrated is a design in which the lower-body first printed-on patterning 41 and the lower-body second printed-on patterning 42 are formed integrally, which is convenient for being formed by screen printing. It will be appreciated that they may be formed by combining a configuration having the pattern of the lower-body first printed-on patterning 41 with a configuration having the pattern of the lower-body second printed-on patterning (if, for example, making them be different colors is desired, they can be formed by carrying out screen printing twice).

The lower-body third printed-on patterning 43 of the present embodying mode is constituted from, as illustrated in FIG. 16, a pair of structures of oblong form (strip pieces) 43a and 43b that extend along the piriformis muscles (905). Being that the strip pieces 43a and 43b extend along the piriformis muscles (905), preferably they are formed to extend from end to end along (from the start point to the end point of) the piriformis muscles. And while depending on the wearer's figure there will be cases where they are not formed to follow the entirety of the piriformis muscles (905), to the extent possible they preferably are created putting together a lineup of sizes (or otherwise made to order) in forms such that the one end and the other end (the start point and the end point) of the piriformis muscles may correspond to the start point and the end point of the strip pieces 42a and 42b.

In the present embodying mode, the lower-body first printed-on patterning 41, the lower-body second printed-on patterning 42, and the lower-body third printed-on patterning 43 are constituted from ink-impressed figures formed by ink being printed on. That is, the lower-body support patternings 40 (41, 42, and 43) are formed, rather than with a taping medium in what was disclosed as one of preferred examples in Patent Document 2, by printing, in the same way as with a shirt 100 of the present embodying modes. In a preferred example of the present embodying mode, the ink-impressed figures constituting the lower-body support patternings 40 are formed by silk-screen printing. Inasmuch as it would be the same as with a shirt 100 of the present embodying modes, a description of silk-screen printing here is omitted.

In the configuration of the present embodying mode, the ink-impressed figures constituting the lower-body support patternings 40 being fashioned by silkscreen printing produces differences in tactile and other properties (difference in texture, with the softness, stretchability, surface smoothness, and other material properties being different) between the pants fabric area and the areas that are printed onto (the lower-body support patternings 40), with the differences in properties activating the muscles to assist capacity for movement. In one example of the present embodying mode, by the ink-impressed figures constituting the lower-body support patternings 40 being formed on the reverse side (surface along the body) of the lower-body piece 30, the lower-body first printed-on patterning 41, the lower-body second printed-on patterning 42, and the lower-body third printed-on patterning 43 are constructed. By the same token, ink-impressed figures (lower-body support patternings 40) can be formed on the obverse side (exposed surface) of the lower-body piece 30 to construct the lower-body first printed-on patterning 41, the lower-body second printed-on patterning 42, and the lower-body third printed-on patterning 43. It will be appreciated that forming the ink-impressed figures on both the obverse side and the reverse side of the lower-body piece 30 to construct the lower-body first printed-on patterning 41, the lower-body second printed-on patterning 42, and the lower-body third printed-on patterning 43 is also possible. This is likewise as with a shirt 100 of the present embodying modes.

Further, the lower-body first printed-on patterning 41, the lower-body second printed-on patterning 42, and the lower-body third printed-on patterning 43 of the present embodying mode can be of, for example, 60 mm or less (preferably, 25 mm±10 mm, or 25 mm to 1 mm) width each. The width of the ink-impressed figures constituting the lower-body support patternings 40 may be made the same as, or may be made different from, the width of the ink-impressed figures constituting the upper-body support patternings 20. And the ink and like conditions may be made the same as (e.g., ink of the same type that is of the same color), or may be made different from (e.g., ink of the same type (or different type) that differs in color), those for the upper-body support patternings 20.

In a configuration of the present embodying mode, the lower-body first printed-on patterning 41, the lower-body second printed-on patterning 42, and the lower-body third printed-on patterning 43 each can be made the same width (such as, for example, 25 mm). Alternatively, the lower-body first printed-on patterning 41, the lower-body second printed-on patterning 42, and the lower-body third printed-on patterning 43 and the upper-body third printed-on patterning 43 may equally well be made differing widths, rather than the same width. This is because by varying the width of the lower-body first printed-on patterning 41, the width of the lower-body second printed-on patterning 42, and the width of the lower-body third printed-on patterning 43 there will be a possibility that the movements of the different muscles can be further activated, and at the same time because there can be instances in which owing to the demands of design it is better that the widths be altered.

Since the human body (skeleton and muscles) is basically bilaterally symmetrical, the lower-body first printed-on patterning 41, the lower-body second printed-on patterning 42, and the lower-body third printed-on patterning 43 each are disposed in a bilateral-symmetrical geometry. In reality, however, the roles of the muscles on the right side and the left side can be different (for example, in a person whose footedness is right-footed, the muscles for kicking, etc. with the right foot are developed), and in that respect, there are instances in which it is preferable, in line with each individual, to dispose the printed-on patternings so as to be bilaterally asymmetrical, following the courses of the muscles on the right side and on the left side. In addition, when there is a situation in which for reasons such as the demands of design—as opposed to right-left differences (subtle differences in each individual) in location of the muscles—rendering a not bilaterally symmetrical disposition is desired, making changes within the range in which the lower body support patternings 40 in the present embodying mode exhibits its functionality is possible. Further, for a lower-body support patternings 40 in the present embodying mode, it is preferable to render the lower-body support patternings 40 with the end portions being at either side (the origin area or the terminal area) of the given muscles; but in cases where, owing to reasons including the demands of design, altering its form is desired, making changes within the range in which the lower-body support patternings 40 in the present embodying mode exhibits its functionality is possible.

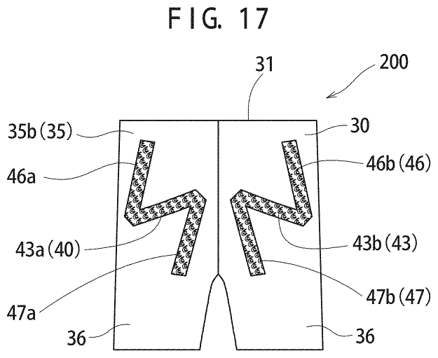

FIG. 17 is a rear-side view illustrating a modified example of the clothing (pants) 200 of the present embodying mode. With the pants 200 illustrated in FIG. 17, in addition to the lower-body third printed-on patterning 43 situated in sites following the piriformis muscle, a lower-body fourth printed-on patterning 46 (46a and 46b) situated in sites following gluteus minimus, and a lower-body fifth printed-on patterning 47 (47a and 47b) situated in sites following sacrotuberous ligaments are further added. In that both the gluteus minimus and sacrotuberous ligaments are muscles that support the movement of the loins, activating (strengthening) these muscles enables strengthening the loins to prevent lower-back pain. The width of the lower-body fourth printed-on patterning 46 (46a and 46b), and the width of the lower-body fifth printed-on patterning 47 (47a and 47b) of the present embodying mode are, for example, 25 mm±10 mm. With the diagrammed configuration examples, what is illustrated is a design in which the lower-body third printed-on patterning 43, the lower-body fourth printed-on patterning 46, and the lower-body fifth printed-on patterning 47 are formed integrally, which is convenient for being formed by screen printing. It will be appreciated that they may be formed by combining a configuration having the pattern of the lower-body third printed-on patterning 43 with a configuration having the pattern of the lower-body fourth printed-on patterning 46 and/or the lower-body fifth printed-on patterning 47 (if, for example, making them be different colors is desired, they can be formed by carrying out screen printing twice or three times).

According to clothing (a shirt) 100 of the present embodying modes, since on an upper-body piece 10 for covering at least a portion of the upper half of the body, the upper-body support patternings 20 are formed, with the upper-body support patternings 20 including the upper-body first printed-on patterning 21 situated in a site following at least a portion of the psoas major muscles (901), the upper-body second printed-on patterning 22 situated in a site following the supraspinatus muscles (903), and the upper-body third printed-on patterning 23 situated in a site following the teres major muscles (904), the muscles are supported, whereby they are activated, enabling the meridians of the Conception Vessel and the Governing Vessel to be made to flow spontaneously. As a result, the wearer's muscles (or otherwise, entire body, including the muscles and joints, etc.) are supported in situations such as during sports, during heavy lifting, or being under nursing care, making improved movement capacity and flexibility possible.

What is more, the fact that the upper-body support patternings 20 are constituted from ink-impressed figures formed by ink being printed on the upper-body piece 10 enables manufacturing costs to be lowered compared with instances in which the upper-body support unit (20) is fashioned by means of a taping medium. To explain further, compared with, in the shirts disclosed in Patent Document 2, what is fashioned utilizing a taping medium, shirts fashioned by printing (especially, fashioned by silk-screen printing) are better suited for manufacturing in small-lot as well as massive-lot production, wherein manufacturing costs thus can be kept under control. Furthermore, in taping-medium implementations, repeated laundering or the like could lead to the taping medium peeling off, so in order to prevent that, sewing the taping medium fast to the shirt with thread is desirable, but doing so increases manufacturing costs. By comparison with taping-medium implementations, constituting the upper-body support patternings 20 with ink-impressed figures in a shirt 100 of the present embodying modes enables them, with the peeling-off of a taping medium being lessened, to be made long-lasting, and at the same time enables manufacturing costs to be kept in check since there is no need for the work of sew-fastening with thread.

What is more, with the clothing (pants) 200 of the present embodying mode, on the lower-body piece 30 for covering at least a portion of the lower half of the body, the lower-body support patternings 40 are formed, with the lower-body support patternings 40 including the lower-body first printed-on patterning 41 situated in sites following at least a portion of the psoas major muscles (901), the lower-body second printed-on patterning 42 situated in sites following the iliacus muscles (902), and the lower-body third printed-on patterning 43 situated in sites following the piriformis muscles (905). Meanwhile, combining clothing (pants, lower-body clothes) 200 of the present embodying mode with a shirt (T-shirt, upper-body clothes) of the present embodying modes, in the same way as with the upper half of the body, in the lower half of the body as well, enables the muscles to be supported, activating them to make the meridians of the Conception Vessel and the Governing Vessel flow spontaneously. Also, the lower-body third printed-on patterning 43 situated in a site following the piriformis muscles (905) facilitates maintaining one's up-and-down and front-and-back balance. What is more, implementations configured with the lower-body fourth printed-on patterning 46 (46a and 46b) situated in sites following the glutei minimi, and the lower-body fifth printed-on patterning 47 (47a and 47b) situated in sites following the sacrotuberous ligaments having been added, by activating (strengthening) muscles that support movement of the loins, enable strengthening the loins to prevent lower-back pain.

With a shirt 100 of the present embodying modes, the upper-body support patternings 20 constituted from ink-impressed figures stimulate meridians including the Conception Vessel and the Governing Vessel, modulating the body by gentle stimulation, and enabling movement capacity/flexibility and the like to be improved. With pants 200 of the present embodying modes, the lower-body support patternings 40 constituted from ink-impressed figures stimulate various meridians in the loins, modulating the body by gentle stimulation, and enabling movement capacity/flexibility and the like to be improved. While taping, in which tape is stretched directly on the body—often used especially by athletes—works to protect muscles, the technology of the present embodying modes utilizes, in contrast to strong stimulation from attaching tape directly, gentle stimulation, and, as it were, thus may be referred to as noncontact-type indirect taping.

### Embodiment Examples

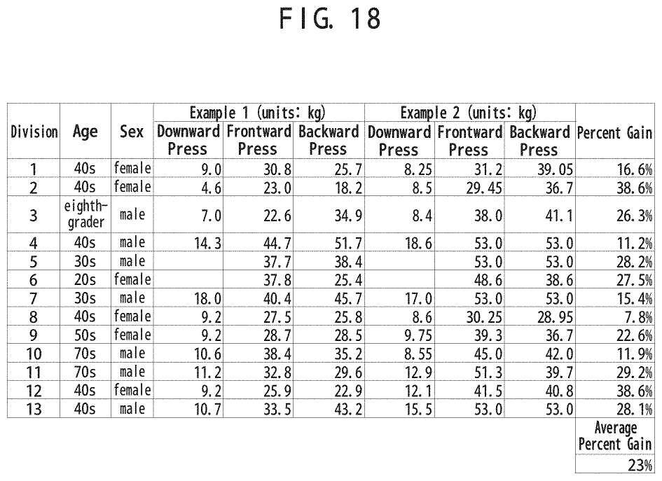

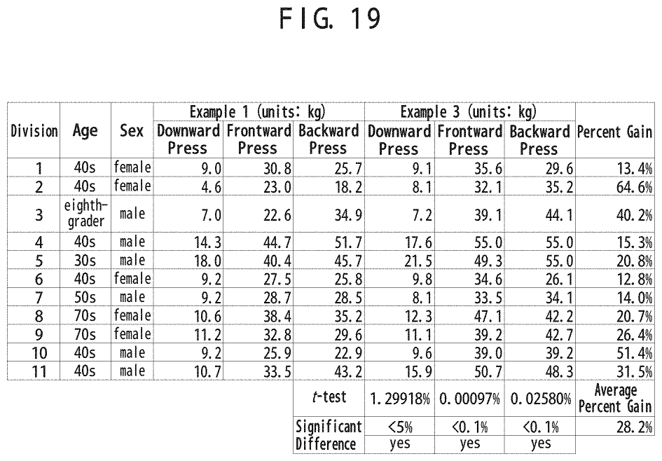

Next, referring to FIG. 18 and FIG. 19, an explanation of embodiment examples (experimental examples and comparative examples) utilizing clothing involving modes of embodying the present invention will be made.

FIG. 18 is a table (experimental results table) presenting results from prior to having test subjects wear (Example 1), and from after having them wear (Example 2), a shirt 100 (being what is represented in FIG. 12 and FIG. 13) and pants 200 (being what is represented in FIG. 15 and FIG. 16) of the present embodying mode. Likewise, FIG. 19 is a table (experimental results table) presenting results from prior to having test subjects wear (Example 1), and from after having them wear (Example 3), a shirt 2000 (being what is represented in FIG. 8 and FIG. 9, an article utilizing a tape medium) and pants 2100 (being what is represented in FIG. 10 and FIG. 11, an article utilizing a tape medium) disclosed in Patent Document 2.

The “Downward Press,” “Frontward Press,” and “Backward Press” presented in FIG. 18 and FIG. 19 are tests as follows. For measuring load (weighting), a measuring instrument called a Mobie Manual Muscle-Strength Gauge was employed (a measuring instrument employed in manual muscle-strength testing—the manual muscle test: MMT). Getting the test subjects to hold onto the manual muscle-strength gauge, the three measurements (“Downward Press,” “Frontward Press,” and “Backward Press”) were made. (1) Arms pressed down. Downward Press: (2-1) Front side of the body is pressed. Frontward Press: (2-2) Rear side of the body is pressed. Backward Press: When the body is about to tumble, the pressing is stopped and the reading on the manual muscle-strength gauge is taken.

To explain further: the (1) Downward Press is a trial that tests the body's effectiveness at being able to withstand a downward (perpendicularly directed) load. In the Downward Press, Person A puts out both hands, placing one hand on top of the other, and Person B presses on Person A's hands from above. With the shirt (pants) not being worn, the hands drop, while with the shirt (pants) being worn, the body is stabilized such that the hands do not drop. Therein, the numbers in the table indicate as experimental results the weightings (units: kg weight) at the moment when the hands dropped. (2-1 and 2-2) The Frontward Press and Backward Press are tests to ascertain whether the trunk going up and down is holding firm. Person A laces together their fingers on both hands and places them in front of their body (in the Frontward Press case). (Or Person A laces together their fingers on both hands and places them behind their body (in the Rearward Press case).) Then Person B sets their fists on the palms of Person A's hands and puts their weight on them. If the trunk holds firm, the body will be steady and not move. With the shirt (pants) not being worn the body will tremble, but with the shirt (pants) being worn the body will be steady. Therein, the numbers in the table indicate as experimental results the weightings (units: kg weight) at the moment when the body is about to tumble.

As will be appreciated from looking at the results for Example 2, and the Example 2 percent gains over Example 1, in FIG. 18, the effectiveness of the shirt 100 (pants 200) of the present embodying modes was confirmed by the tests. The tests (13 persons) were conducted with various individuals (ages, sexes), wherein with all individuals, effectiveness was recognized (percent gain was positive), with the average percent gain being 23%. This means a that much further gain, being about V4 of ordinary strength, was confirmed. The individual with the maximum gain had an increase that was 38.6%.

In the same testing, the effectiveness of the shirt 2000 (pants 2100) disclosed in Patent Document 2 was as a reference also tested. As will be appreciated from looking at the results for Example 3, and the Example 3 percent gains over Example 1, in FIG. 19, the effectiveness of this shirt 2000 (pants 2100) also was confirmed by the tests. The tests (11 persons) were conducted with various individuals (ages, sexes), wherein with all individuals, effectiveness was recognized (percent gain was positive), with the average percent gain being 28.2%. It should be noted that in the table presented in FIG. 19, numbers (%) and significant difference (all “yes”) from a t-test are also entered.

Inasmuch as the effectiveness of the shirt 100 (pants 200) of the present embodying modes was a 23% average percent gain (FIG. 18), while the effectiveness of the shirt 2000 (pants 2100) was a 28.2% average percent gain (FIG. 19), an elevated effectiveness in physical capacity (physical-stability-based capacity to withstand loads) that was roughly equal in both instances was confirmed. This means the fact that exploiting a shirt 100 (pants 200) composed from ink-impressed figures in the configuration of the present embodying modes demonstrated effectiveness equal to, and in the same way as, that of the shirt 2000 (pants 2100) disclosed in Patent Document 2 was confirmed by the testing.

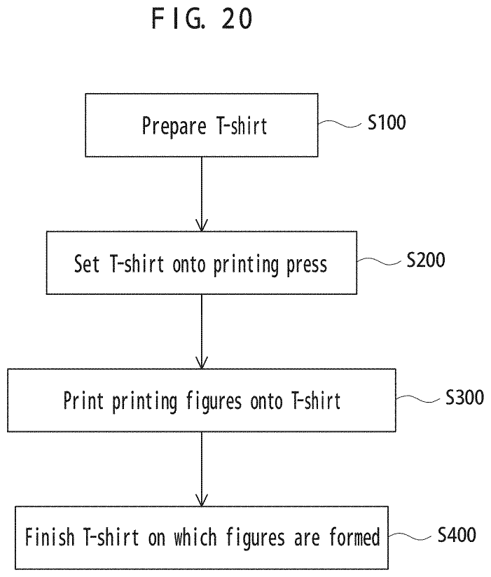

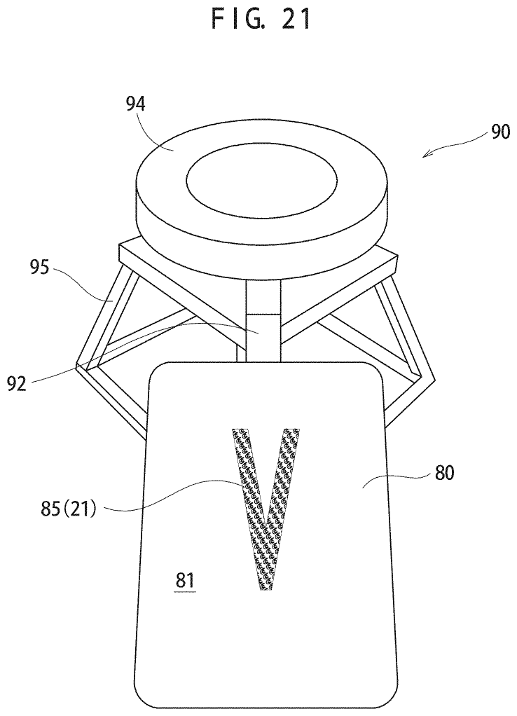

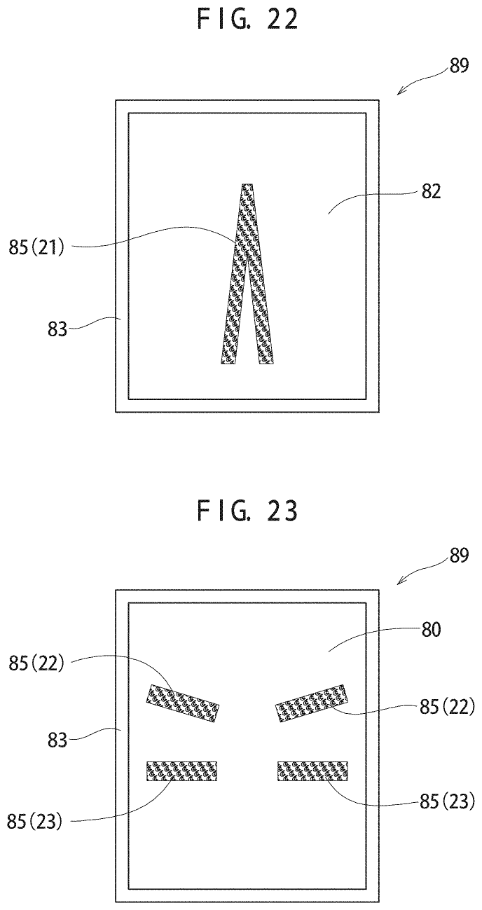

Next, with reference to FIG. 20 through FIG. 23, a method of manufacturing a shirt 100 of the present embodying mode will be described. FIG. 20 is a flowchart for explaining the method of manufacturing the shirt 100 of the present embodying mode. FIG. 21 is a silkscreen printing device 90, one that carries out printing (screen printing) onto shirts, fashioning upper-body support patternings 20 (21 and 22). FIG. 22 is a printing screen 89 for printing an upper-body support patterning 20 (upper-body first printed-on patterning 21). Lastly, FIG. 23 is a printing screen 89 for printing upper-body support patternings 20 (upper-body second printed-on patterning 22 and upper-body third printed-on patterning 23).

As indicated in FIG. 20, to begin with, a T-shirt (here, a blank T-shirt) is prepared (Step S100). Next, the T-shirt is set onto the printing press 90 represented in FIG. 21 (Step S200).

The printing press 90 represented in FIG. 21 is a silkscreen printing press 90 for T-shirt printing. On the printing press 90, a printing-job pallet 80 covered with a T-shirt, and with the material on the printing side up, is provided. In the diagrammed printing press 90, the printing-job pallet 80 is connected to a printing-support turntable 94 by a supporting extension rod 92. The printing-support turntable 94 is supported by a device pedestal 95, wherein it can be rotated centered on the pedestal 95. In the diagrammed example, the FIG. 85 (21) that will be printed on is drawn on the surface 81 of the printing-job pallet 80 in a way such that the pattern and printing position of the upper-body first printed-on patterning 21 are easily apprehended.

FIG. 22 is a printing screen 89 (screen-printing sheet) for printing the upper-body first printed-on patterning 21. A screen (mesh) 82 is stretched onto a tensioning frame 83. A pattern (apertures in the mesh) 85 defining the upper-body first printed-on patterning 21 is formed on the stencil 82. FIG. 23 is a printing screen 89 (screen-printing sheet) for printing the upper-body second printed-on patterning 22 and the upper-body third printed-on patterning 23.

Next, the printing figures are printed onto the T-shirt (Step S300). Specifically, with the T-shirt having been set on the printing-job pallet 80 of the printing device 90 in FIG. 21, the printing screen 89 illustrated in FIG. 22 is placed onto the T-shirt. Ink is loaded onto, and with a squeegee is rubbed over (pressed against and moved along), the stencil 82 in the printing screen 89, thereby completing the printing of the upper-body first printed-on patterning 21 (completion of front-side printing). Then once the ink has dried, the T-shirt is set, so that its back side will be up, on the printing-job pallet 80 of the printing device 90, and this time the printing screen 89 illustrated in FIG. 23 is put in place. Subsequently, ink is loaded onto, and with a squeegee is rubbed over (pressed against and moved along), the stencil 82 in the printing screen 89, thereby completing the printing of the upper-body second and third printed-on patternings (22 and 23). In this way, the shirt 100 of the present embodying mode (T-shirt on which FIGS. 21 to 23 are formed) is finished (Step S400). By the executing of similar steps, pants 200 of the present embodying mode can also be manufactured (printed onto).

Thus, the manufacturing method of the present embodying mode is convenient in that it enables manufacturing the shirts/pants (2000 and 2100) disclosed in Patent Document 2 readily in large volume as well as at low cost. The method accordingly facilitates broadly, rapidly popularizing clothing (100, 200) of this sort that improves physical/exercise capacity. It should be noted that it does not matter if the manufacturing device (printing device) of the present embodying modes, not limited to being the configuration of the device 90 represented in FIG. 21, is of another configuration. For example, the manufacturing apparatus (printing apparatus) may be of a kind in which numerous printing-job pallets 80 and printing screens 89 that correspond to them are placed side by side in rows.

Next, while referring to FIG. 24 and FIG. 25, an explanation will be made of a configuration in which a shirt 100 and pants 200 involving the present embodying mode are combined. FIG. 24 and FIG. 25 are a front side view and a back side view illustrating a configuration, involving a present embodying mode, in which a shirt 100 and pants 200 are combined. Although the pants 200 depicted in FIG. 17 are shown therein, they may be the pants 200 depicted in FIG. 16. The user (wearer) 500 is wearing a top/bottom set of clothing 300—namely, is wearing both the shirt 100 and the pants 200.

As indicated in FIG. 24 and FIG. 25, combining the shirt 100 and pants 200 (top/bottom clothing) involving the present embodying mode makes possible the creation of areas that support, as indicated in FIGS. 3A, 3B and 3C, sites following the psoas major muscles 901, sites following the iliacus muscles 902, sites following the supraspinatus muscles 903, sites following the teres major muscles 904, and sites following the piriformis muscles 905 (areas that impart stimuli to the muscles). In particular, as indicated in FIG. 24, the upper-body first printed-on patterning 21 and the lower-body first printed-on patterning 41 form an assemblage, wherein as a result areas that support (areas that impart stimuli to the muscles) can be created in sites following the psoas major muscles 901 (zones spanning their entire range).

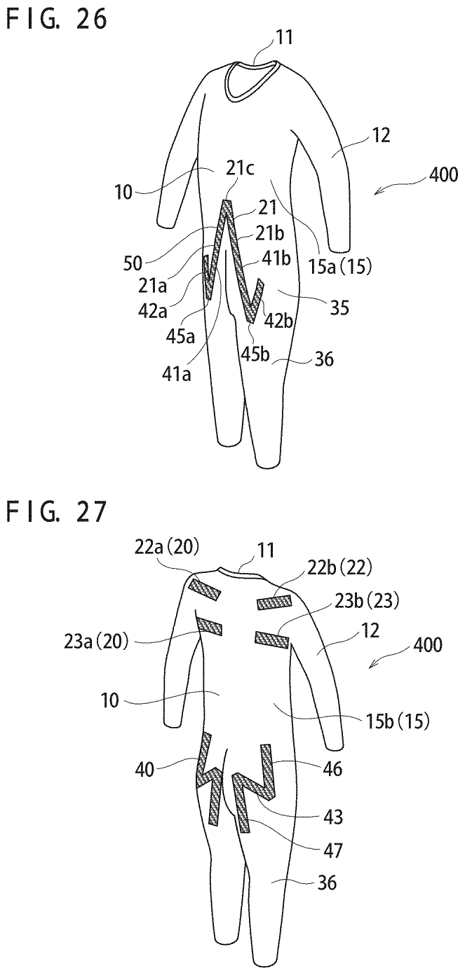

Furthermore, the mode may be not only combining a shirt 100 and pants 200 (top/bottom clothing) involving the present embodying mode, but also a “skinsuit” in which the top/bottom clothing is made unitary. FIG. 26 and FIG. 27 respectively illustrate the front-side configuration and the back-side configuration of clothing (a skinsuit) 400 involving a present embodying mode. Now herein, the fact that while in the back-side configuration illustrated in FIG. 27, the figures on the pants 200 shown in FIG. 17 are depicted, they may be the figures on the pants 200 shown in FIG. 16 is as stated earlier.

In a skinsuit 400 involving the present embodying mode, the upper body piece 10 includes the lower body piece (30) to take on a unitary configuration (upper and lower clothing core pieces). So as to make putting it on and taking it off easier, the skinsuit 400 may be provided along a portion thereof (the back etc.) with buttons, a zipper, or the like. The skinsuit 400 is tantamount to coveralls for construction venues and coveralls for work (e.g., automotive servicing etc.) in workshops, as well as to full body tights, wet suits used for surfing or scuba diving, and swimsuits, etc.

In the foregoing, preferred modes of embodying the present invention have been described, yet such descriptions are not limiting items, and of course, various modifications are possible. The above-described embodying modes as well as the configurations of modified examples as well as the techniques are applicable each to the other. For example, with the configuration of a shirt (100) of the present embodying modes, given the difficulties during nursing care with changing a patient's clothes or with the patient changing clothes, the configuration may be a mode in which buttons, or a zipper are put on the shirt to make it so the front opens. Also, although with regard to shirts, chiefly T-shirt modes have been described, in golf, since collared articles are basically required, configuring the shirts with collars is preferable. Further, since the lower-body third printed-on patterning 43, situated in sites following the piriformis muscles 905, alleviates what would be intensifying of the feeling of being tugged at by an attractive force, in situations where there need not be concern about that odd sense, it is possible to take off the lower-body third printed-on patterning 43.

### INDUSTRIAL UTILIZABILITY

According to the present invention, in clothing that supports the wearer's muscles to enable improving capacity for and flexibility in movement in situations such as during sports, during heavy lifting, or being under nursing care, made available is clothing that enables its manufacturing costs to be reduced, and/or that despite being laundered or the like enables tape peel-off to be prevented.

### DESCRIPTION OF REFERENCE MARKS

10: Upper body piece
11: Collar section
12: Sleeve section
15: Trunk portion
20: Upper-body support patternings
21: Upper-body first printed-on patterning
22: Upper-body second printed-on patterning
23: Upper-body third printed-on patterning
30: Lower-body piece
31: Waist section
32: Opening
35: Above-crotch section
36: Below-crotch section
40: Lower-body support patternings
41: Lower-body first printed-on patterning
42: Lower-body second printed-on patterning
43: Lower-body third printed-on patterning
46: Lower-body fourth printed-on patterning
47: Lower-body fifth printed-on patterning
70: Printing stencil sheet
80: Printing-job pallet
82: Screen (mesh)
83: Tensioning frame
89: Printing screen
90: Printing press (silkscreen printing device)
100: Shirt (T-shirt)
200: Pants
300: Top/bottom set of clothing
400: Skinsuit
500: User (Wearer)
900: Human
901: Psoas major muscle
902: Iliacus muscle
903: Supraspinatus muscle
904: Teres major muscle
905: Piriformis muscle
1000: athletic wear
2000: shirt (T-shirt)
2100: trousers (pants)

1. Clothing for covering the body of a wearer, the clothing comprising:
an upper-body piece for covering at least a portion of the upper half of the body; and
upper-body support patternings formed on the upper-body piece; wherein
the upper-body support patternings include
an upper-body first printed-on patterning situated in a site following at least a portion of the psoas major muscle,
an upper-body second printed-on patterning situated in a site following the supraspinatus muscle, and
an upper-body third printed-on patterning situated in a site following the teres major muscle; and
the upper-body support patternings are constituted from ink-impressed figures formed by ink being printed on said upper-body piece.

2. The clothing set forth in claim 1, wherein:
the ink is compounded with a mineral powder of at least one kind or a blended mineral powder of two or more kinds selected from the group consisting of radium ore, germanium, quartz, terahertz ore, and tourmaline.

3. The clothing set forth in claim 1, wherein:
the upper-body piece has the form of a T-shirt; and
the ink-impressed figures are formed by silk-screen printing in which
the upper-body first printed-on patterning is of 25 mm±10 mm width, and
the upper-body second printed-on patterning and the upper-body third printed-on patterning each are of 50 mm±10 mm width.

4. The clothing set forth in claim 1, wherein the upper-body first printed-on patterning, the upper-body second printed-on patterning, and the upper-body third printed-on patterning each are disposed in a bilateral-symmetrical geometry.

5. Clothing for covering the body of a wearer, the clothing comprising:
an upper-body piece for covering at least a portion of the upper half of the body; and
upper-body support patternings formed on the upper-body piece; wherein
the upper-body support patternings include
an upper-body second printed-on patterning situated in a site following the supraspinatus muscle, and
an upper-body third printed-on patterning situated in a site following the teres major muscle; and
the upper-body support patternings are constituted from ink-impressed figures formed by ink being printed on said upper-body piece; and wherein
the upper-body piece has the form of a T-shirt, and
the ink-impressed figures are formed by silk-screen printing.

6. The clothing set forth in claim 5, wherein:
the ink is compounded with a mineral powder of at least one kind or a blended mineral powder of two or more kinds selected from the group consisting of radium ore, germanium, quartz, terahertz ore, and tourmaline.

7. The clothing set forth in claim 5, wherein:
the upper-body second printed-on patterning and the upper-body third printed-on patterning each are of 50 mm±10 mm width; and
the upper-body second printed-on patterning and the upper-body third printed-on patterning each are disposed in a bilateral-symmetrical geometry.

8. Clothing for covering the body of a wearer, the clothing comprising:
a lower-body piece for covering at least a portion of the lower half of the body; and
lower-body support patternings formed on the lower-body piece; wherein
the lower-body support patternings include
a lower-body first printed-on patterning situated in a site following at least a portion of the psoas major muscle,
a lower-body second printed-on patterning situated in a site following the iliacus muscle, and
a lower-body third printed-on patterning situated in a site following the piriformis muscle; and
the lower-body support patternings are constituted from ink-impressed figures formed by ink being printed on said lower-body piece.

9. The clothing set forth in claim 8, wherein:
the ink is compounded with a mineral powder of at least one kind or a blended mineral powder of two or more kinds selected from the group consisting of radium ore, germanium, quartz, terahertz ore, and tourmaline.

10. The clothing set forth in claim 8, wherein:
the lower-body piece has the form of shorts; and
the ink-impressed figures are formed by silk-screen printing in which
the lower-body first printed-on patterning, the lower-body second printed-on patterning, and the lower-body third printed-on patterning each are of 25 mm±10 mm width.

11. The clothing set forth in claim 8, wherein the lower-body first printed-on patterning, the lower-body second printed-on patterning, and the lower-body third printed-on patterning each are disposed in a bilateral-symmetrical geometry.

12. The clothing set forth in claim 8, wherein:
the lower-body support patternings further include
a lower-body fourth printed-on patterning situated in a site following the gluteus minimus, and
a lower-body fifth printed-on patterning situated in a site following the sacrotuberous ligament.

13. Clothing for covering the body of a wearer, the clothing comprising:
upper and lower clothing core pieces for covering at a least a portion of the upper half of the body and at least a portion of the lower half of the body; and
support patternings formed on the upper and lower clothing core pieces; wherein
the support patternings include
a first printed-on patterning situated in a site following the psoas major muscle,
a second printed-on patterning situated in a site following the iliacus muscle,
an upper-body second printed-on patterning situated in a site following the supraspinatus muscle,
an upper-body third printed-on patterning situated in a site following the teres major muscle, and
a lower-body third printed-on patterning situated in a site following the piriformis muscle; and
the support patternings are constituted from ink-impressed figures formed by ink being printed on said upper and lower clothing core pieces.

14. The clothing set forth in claim 13, wherein:
the ink is compounded with a mineral powder of at least one kind or a blended mineral powder of two or more kinds selected from the group consisting of radium ore, germanium, quartz, terahertz ore, and tourmaline.

15. The clothing set forth in claim 13, wherein:
the support patternings further include
a lower-body fourth printed-on patterning situated in a site following the gluteus minimus, and
a lower-body fifth printed-on patterning situated in a site following the sacrotuberous ligament.

16. The clothing set forth in claim 13, wherein the ink-impressed figures constituting the support patternings are formed by silk-screen printing in which
the ink-impressed figures are of 60 mm or less width.

17. A method of manufacturing support clothing for supporting a wearer's capacity for movement, the manufacturing method including:
a step of preparing an upper-body piece for covering at least a portion of the upper half of the body; and
a step of forming, by silk-screen printing on at least one of an obverse side or a reverse side of the upper-body piece fabric,
an upper-body first printed-on patterning situated in a site following at least a portion of the psoas major muscle,
an upper-body second printed-on patterning situated in a site following the supraspinatus muscle, and
an upper-body third printed-on patterning situated in a site following the teres major muscle.

18. The method set forth in claim 17, wherein:
in the step of forming by silk-screen printing,
a printing screen defining the upper-body first printed-on patterning to be of 25 mm±10 mm width, and the upper-body second printed-on patterning and the upper-body third printed-on patterning each to be of 50 mm±10 mm width is employed; and
in the printing screen, the areas defining the upper-body first printed-on patterning, the upper-body second printed-on patterning, and the upper-body third printed-on patterning each are disposed in a bilateral-symmetrical geometry.

19. The method set forth in claim 17, wherein:
an ink in the silk-screen printing is compounded with a mineral powder of at least one kind or a blended mineral powder of two or more kinds selected from the group consisting of radium ore, germanium, quartz, terahertz ore, and tourmaline.

20. A method of manufacturing support clothing for supporting a wearer's capacity for movement, the manufacturing method including:
a step of preparing a lower-body piece for covering at least a portion of the lower half of the body; and
a step of forming, by silk-screen printing on at least one of an obverse side or a reverse side of the lower-body piece fabric,
a lower-body first printed-on patterning situated in a site following at least a portion of the psoas major muscle,
a lower-body second printed-on patterning situated in a site following the iliacus muscle, and
a lower-body third printed-on patterning situated in a site following the piriformis muscle.

21. The method set forth in claim 20, wherein in the step of forming by silk-screen printing, further forming by silk-screen printing
a lower-body fourth printed-on patterning situated in a site following the gluteus minimus, and
a lower-body fifth printed-on patterning situated in a site following the sacrotuberous ligament is carried out.

22. The method set forth in claim 20, wherein:
an ink in the silk-screen printing is compounded with a mineral powder of at least one kind or a blended mineral powder of two or more kinds selected from the group consisting of radium ore, germanium, quartz, terahertz ore, and tourmaline.
